(19) United States
(12) Patent Application Publication
(10) Pub. No.: US 2010/0067673 A1
(43) Pub. Date: Mar. 18, 2010

(54) DYNAMIC OPERATION INTERFACE SYSTEM FOR ACCESS TERMINALS, A SHARING SYSTEM AT ACCESS TERMINALS, A MODULAR SYSTEM FOR ADMINISTERING AND CONTROLLING ACCESS TERMINALS AND A PUBLIC ACCESS SYSTEM AT A TERMINAL WITH TELEPHONY

(75) Inventor: Eduardo Medeiros de Medeiros, Porto Alegre (BR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: FONET SOLUÇÖES DE TELEMÁTICA LTDA., Porto Alegre-RS (BR)

(21) Appl. No.: 12/438,508

(22) PCT Filed: Jul. 27, 2007
(86) PCT No.: PCT/BR2007/000191

§ 371 Date: Nov. 9, 2009

(30) Foreign Application Priority Data
Aug. 21, 2006 (BR) PI0603467-5

(51) Int. Cl. H04M 11/00

(52) U.S. Cl. 379/93.17

(57) ABSTRACT

The present invention relates to a public access system provided with an interface system for public access terminals with telephony (1), which has the objective of simplifying the operation and interaction of users through automatic conversion of information from databank, texts and miscellaneous contents. The interface means (11) is installed at a public access terminal with telephony (1) and comprises a display means (12) operated directly by screen touch, through hierarchical buttons (13), generated dynamically and in real time by automatic procedures carried out through a remote dynamic contents control station (4) or manually, effected by an administrative area (5). The user can further have access to customized information by means of an access card (6), which, upon being inserted into the reader (2) at the public access terminal (1), enables, through a sharing system, that determined companies share terminals and terminal networks with each other and with the users, temporarily providing the same access resources and services made available by companies that have dedicated terminals for their target public. The invention further relates to a system provided with at least one modular administration and control device (15) controlling public access terminals (1) with telephony, which has the objective of controlling any number of public access terminals (1), independently of the number of applications and independently of each other, the modular devices (15) further being arranged in layers (16, 18) of the equal or different hierarchies, according to the needs of expansion, security, velocity, latency, control, among others.

### FIELD OF THE INVENTION

The present invention relates to system for public access terminals with telephony, which simplifies the operation and interaction of users through automatic conversion of databank information, texts and miscellaneous contents.

The invention also relates to a system for public access terminals with telephony, which enables companies to share terminals and terminal networks, temporarily providing the same access means and services available for companies that have dedicated terminals for their target public, sharing terminals and terminal networks between companies and services, such as expenses of production, installation, maintenance, availability, supervising, etc., the services of one or more of the selected companies being available to the final user.

In addition, the invention further describes a modular system for administering and controlling access terminals and a public access system at terminals with telephony, which makes possible the control of any number of terminals, as well as any volume of performance applications at these terminals without limitations of capacity.

### DESCRIPTION OF THE PRIOR ART

The other public access terminals provide an opportunity of communication between companies, such as commercial establishments, shopping centers, banks, drugstores, etc., and their public, which may be actual consumers or potential consumers. As in any media, consumers are attracted by the access to information and digital interaction with the companies and by offers of their products and goods.

However, what is observed in practice is that public access terminals are a privilege of a few companies, due to the expenses of production, installation, maintenance, availability, supervising, etc., which few of them can afford. In reality, what is observed is that only big companies such as banks, big shops, coffee-house networks, etc., make this type of terminal available to their clients in an external environment, while small companies remain restricted to the internal environment of their establishments.

In addition, the existing public access terminal have complex control structures, often centralized, which makes it difficult to expand the number of terminals and services rendered, due to a wide range of problems, as for instance the latency of execution of the applications, difficulties in controlling networks in expansion, lack of modularity, etc. The solutions found at present in the market aim at increasing the handling capacity of the public access terminals by increasing the band broadness (with the consequent increase in communication speed) and increasing the remote data processing structures (datacenters), which would solve the problem partially, since the problems of delay and latency of the Internet are intermittent and in independent chains and often the mere improvement in band broadness rearward capacity is not sufficient.

In spite of the benefits provided by these terminals, a less skilled user encounters a number of difficulties in looking for updated information, since the interfaces are based only on links of Internet navigators or worked out with a static content. Even a more skilled user needs to find the desired service or information quickly, due to the time limitations that a public service requires. In some situations the clients do not feel at ease for consulting attendants at establishments and suppliers, for a number of reasons, such as lack of time, shame, lack of knowledge, etc. Although the technology of Internet navigators and multimedia static interfaces at public access terminals have evolved greatly in the last decades, the lack of interactivity and dynamism at these interfaces is a strong obstacle for the proliferation of these terminals.

The prior art further provides some teachings relating to public access terminals with telephony, as can be seen in documents WO 02/056139 A2 and FR 2,783,303. Both documents refer to the need to provide services for users from navigation links defined by the sponsors of the public access terminal with telephony. However, at no time there is the concern of definition of an interface that can be operated through dynamic hierarchical buttons, the same navigation concept of Internet navigation found in conventional desktop computers.

Besides, both in document WO 02/056139 A2 and in document U.S. Pat. No. 6,118,860, for instance, the whole communication of the user with the services is defined through the link URLs, and there is no definition of the dynamic generation of buttons associated to the URLs, let alone an automatic generation of these buttons as proposed in the present invention.

Even in more recent documents such as U.S. Pat. No. 6,876,737, there is no reference to the use of a hierarchical dynamic interface that can be generated either manually or automatically from a set of links or databanks.

What is observed in the prior art is the permanent interface model with the user, but not of the model of information generation that will be used by the user, mainly with regard to the dynamic generation of this information that facilitates the use by the suppliers of the terminals, which are the system administrators.

In order to exemplify what has been set forth above, it is possible to consider FIG. 5 of document U.S. Pat. No. 6,876,737 as a reference, where there is a description of various elements existing in the functioning of the terminal, which refer to the interface with the user, such as sending or receiving e-mails. The services are detailed, but as a closed application and with closed resources, something that the present invention considers fundamental to be dynamic, so as to enable many companies to use the terminal to provide their users with the means with a customized interface for each company.

### OBJECTIVES OF THE INVENTION

Considering the problems described and with a view to overcome them, the present invention proposes a novel interface system with dynamic operation, so as to enable the transformation of contents of databanks, texts, miscellaneous Internet contents, on-line services, etc., in a set of easy-navigation hierarchical buttons, updated in real time, according to what has been established by the information suppliers.

Another objective of the invention is to provide a modular system easy to install and to interconnect, which enables one to control any number of public access terminals, independently of the amount of applications.

A further objective of the invention is to make unnecessary the existence of data processing centers (datacenters) or hosting providers for control over the network of public access terminals with telephony, being able to operate in a way totally autonomous and independent of other devices and systems.

Another problem to be solved by the present invention is the information cryptography between the public access terminal with telephony and the remote content provider, according to the level of privacy of the user and secrecy of the information that is in transit.

Additionally, the present invention provides a sharing system that enables companies to share terminals and terminal networks, temporarily supplying the same access means and services provided by companies that have dedicated terminals for their target public.

### SUMMARY OF THE INVENTION

The present invention relates to a public access system with telephony, composed of a system for public access terminals that simplifies the operation and interaction of the users by automatically converting information of databanks, texts and miscellaneous contents into hierarchical operation buttons, called dynamic operation interface; a modular system for administration and control of public access terminals with telephony, which enables the control of a number of terminals and any volume of execution applications at these terminals, without capacity limitations and without the existence of data processing centers or hosting providers, with total autonomy of operations; and a sharing system inserted into public access terminals, which enables companies to share terminals and terminal networks, temporarily providing the same access means and services that are made available by companies that have dedicated terminals for their target public.

Through this system, the user can interact with the terminal in a fast and dynamic manner, obtaining information by inputting information directly into a screen or display, and the interface system can be used at any public access terminal with telephony, as for instance banking consultation terminals, multimedia terminals, terminals with Internet access, etc., with the means and services totally shared between companies, so as to provide temporarily the same access resources and services made available by companies that have dedicated terminals for their target public, since the public access terminals have the modularity resource, obtained by interconnection of identical modules adjusted for specific applications through a set of business rules.

### BRIEF DESCRIPTION OF THE DRAWINGS

FIG. 1 illustrates the public access terminal in one of its possible embodiments, having a number of devices integrated to the public access system.

FIG. 2 shows a scheme of communication between the public access terminal with telephony and the control station and the administrative area for implementation of the dynamic interface and of the sharing of terminals with the companies.

FIG. 3 illustrates the screen of the public access terminal with telephony without the use of the dynamic access interface, provided with remote access links.

FIG. 4 shows the screen of the public access terminal with telephony after using the dynamic access interface system, with the links transformed into touch-sensitive areas.

FIG. 5 illustrates an interconnection scheme between a set of public access terminals and the systems of administration and control of these terminals at levels of layers having the same hierarchy.

FIG. 6 illustrates an interconnection scheme of the modular systems for administering and controlling public access terminals in layers of different hierarchies.

### DETAILED DESCRIPTION OF THE FIGURES

The present invention relates to a public access system that enables the final user to input and interact and brings about the convergence of the most varied on-line resources and services, with simplified operation at a simple touch on the key of a monitor.

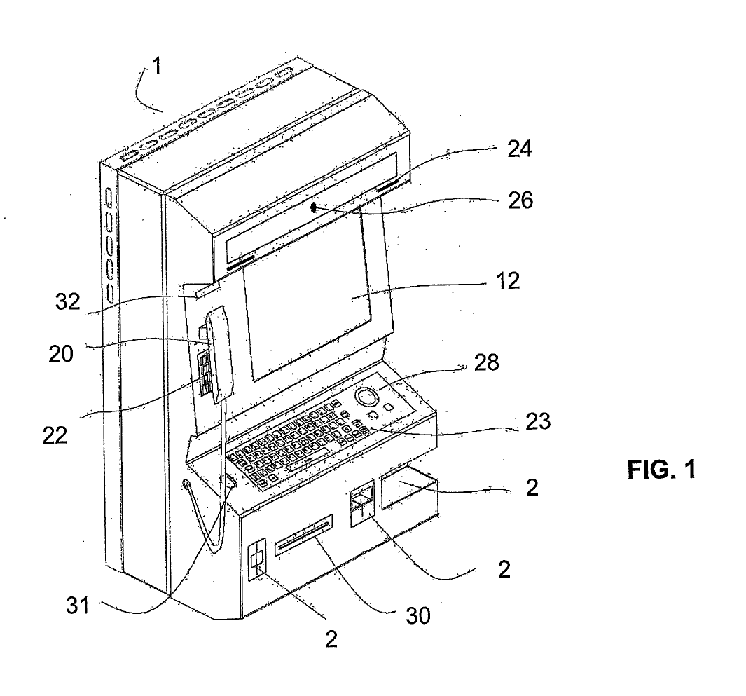

As can be seen in FIG. 1, the interface system is installed at a public access terminal 1 with telephony, comprising a telephone 20 with a monophone, within the public telephony standards, at least one display device, preferably a plane-screen touch-sensible digital monitor or display (touch screen) 12, and may further comprise a physical or virtual keyboard for inputting data, the physical one having a tactile element for visually disabled persons, a QWERTY 23 physical or virtual keyboard, the physical one having a tactile element for visually disabled persons, audio device 24, camera 26, mouse 28, printing device 30, biometric sensor 31 and at least one telephone visor 32, either physical or virtual.

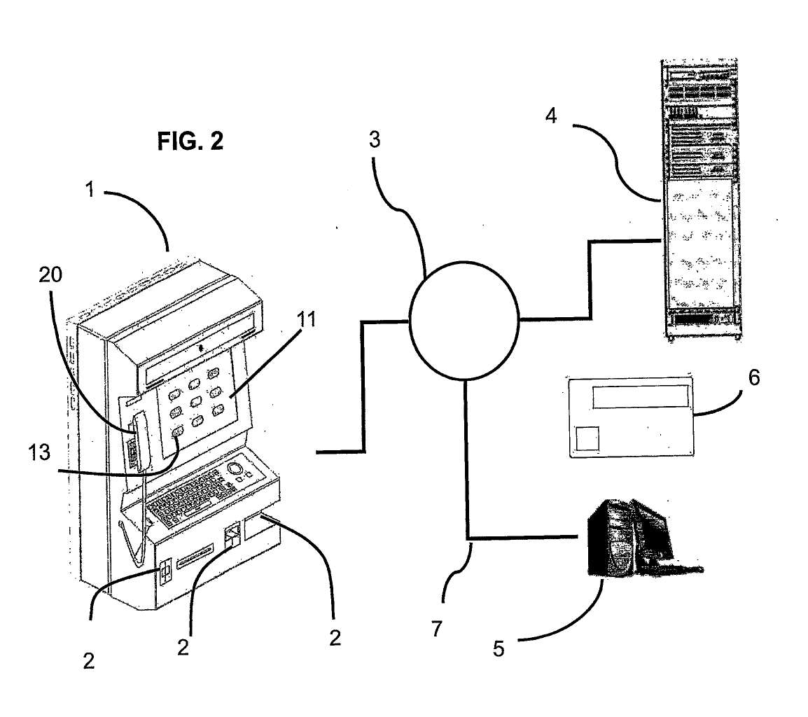

The interface device 11, according to FIG. 2, can be operated in an autonomous manner by the public (self-service), being operated directly by touch on the screen, through hierarchical buttons 13 generated dynamically in real time.

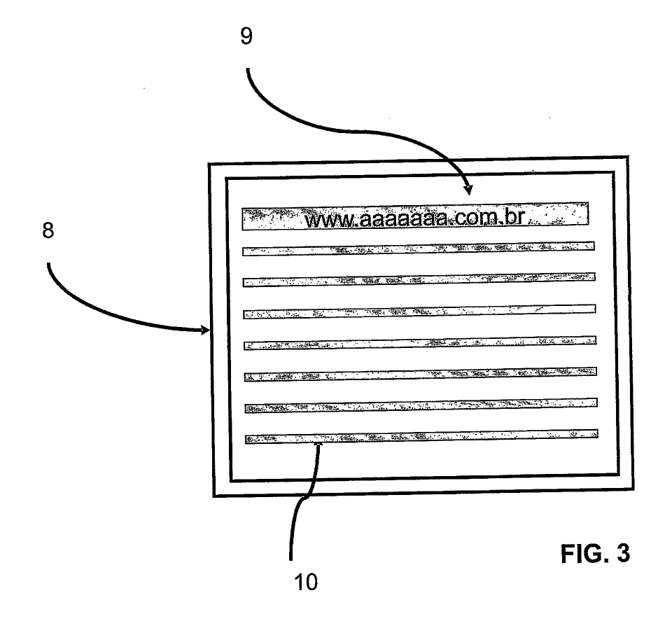

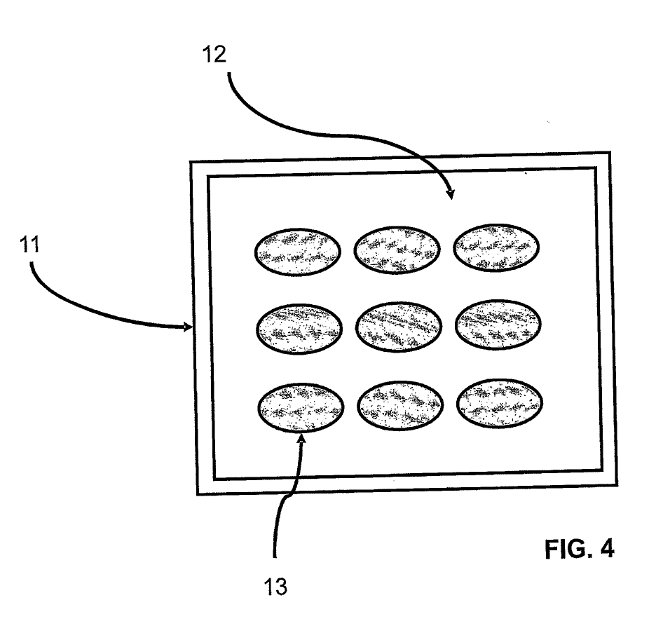

By way of comparison, FIG. 3 illustrates the display 8 without the dynamic interface system, with the contents displayed on the screen before being converted into a user-friendly format, in the links format 10 or any other information of databank and/or text, while FIG. 4 illustrates the display 12 after conversion of the links into hierarchical buttons of the dynamic interface 13, sensitive to the touch.

The interface device 11 makes available, in real time, the automatic generation of hierarchical operation buttons, by consultation and communication in network 3 with a remote station 4 for control over dynamic contents, at first using the Ethernet standard and the TCP/IP Internet protocol, although it is possible to apply any other protocol or standard of physical or logical network.

The control station 4 is composed of a set of servers arranged on a rack or modular cabinet, which perform various operational systems, wherein each server is responsible for a specific activity, as for instance management of the databank, management of the dynamic interface, management of the access control, management of the telephony, and so on, with various types of independent operational systems found on the market, also inter-connected by network 3. However, nothing prevents the control station from functioning in the same manner as a data processing center or datacenter.

At this control station 4 it is possible to carry out, manually or automatically, the conversion of any contents stored in a databank or in the links format 10, as shown in FIG. 3, into the following elements, which enable the generation of the hierarchical generation buttons:
Group: it identifies the hierarchical level;
Title: it specifies the label or text that will be presented on the dynamic button;
Order: it organizes the sequence and quadrant of presentation of each button, for example, in the form of a matrix;
Link: it routes to the contents desired by the user, enabling navigation through the dynamic interface;
Image: it makes relationship with the image bank stored in the gallery of the module, or generated automatically according to the contents to be displayed; and
Theme: customization of the presentation form in the terminal interface.

By means of a connection 7, preferably an Ethernet one with TCP/IP protocol in the Internet standard, which may still be replaced by another type of connection, according to the needs of the market, the control station 4 and the administrative area 5 are interconnected, and this is the place where all the adjustment and control of the business rules are carried out, which are composed by the set of definitions that determine how the public access terminals will operate, which services will be offered, which charges will be applied according to various factors—such as time, place, etc-, at what times each service will be made available, which companies may or may not use the public access terminal to provide services for their users, etc. The administrative area 5 is composed both by the administration team of the company that owns the terminals during the time of use by the user (company that is sharing the terminal), according to their functioning rules, and has access to the final contents interface adjustments, as for instance, to the image gallery, which has the objective of facilitating the understanding of the service offered by a determined button (in this gallery one can easily add images through the system, where the dynamic interface system adapts such images, determining their sizes and positions so that they will systematically appear at the final user interface).

The process of generating hierarchical buttons 13 of the dynamic interface 11 may be carried out both manually by the administrative area 5 and automatically by the control station 4. In the manual generation, the administrative area 5 exactly defines the parameters ‘Group’, ‘Title’, ‘Order’, ‘Link’, ‘Image’ and ‘Theme’. In the automatic generation, the control station 4 processes a screen with texts or links 10 that would be normally displayed on a screen 9 without interface 8, with a text format. The result of such processing is the generation of the hierarchical buttons 13 of the dynamic interface, converted automatically from the original contents, in real time, by the control station 4.

Further as shown in FIGS. 1 and 2, the public access terminal with telephony 1 has also one or more reading devices 2 to read or identify identification means 6, herein called company cards 6, independently of the type of media, as credit card, debit card, magnetic strip card, inductive cards (telephone cards), smart cards, access-password cards, etc., and independently of the type of reader, such as magnetic stripes, chips, inductive, bar-code, digital cards, etc.

The card 6 is owned by the user who is a client of the company that is sharing the public access terminal with telephony 1. Basically, the model used for this identification is similar to the public keys (reader and sharing system) and private keys (user access card) system, in which the keys give access to the public access terminal 1, this access being authorized by the control station 4. The card 6 must be only inserted into or detected by the reading device 2 installed at the public access terminal 1, and exactly the contents made available by the company that is sharing the terminal will be presented to the user on the terminal screen. The contents may be simply the Internet page of the company or another content dedicated to the systems that will be made available.

The card 6 may still be replaced by a virtual card with a code or password input by the user into the keyboard 22 or into the QWERTY keyboard 23, inputting it directly into the touch-sensitive key 12, or still by means of a bar code recognized by the reader 2, and the code or password may have been supplied in printed form by a document or product of the company that is sharing the access terminal.

The user and company identifying process is carried out by consulting the terminal by network connection 3 to the control station 4, also connected to the network 3, the network being compatible with the market standards already set forth, such as Ethernet and TCP/IP Internet, but it may be adapted to closed standards, as in the communication of the control station 4 with specific protocols of the company that is sharing the access terminals, which is common in the case of department stores and banks, e.g. for the sake of safety, using, in this case, from the early protocols like Renpac to closed VPN networks.

Between the insertion of the card by the user and the presentation of the contents of the company that is sharing the public access terminal 1, determined steps are performed, as one of the possible embodiments for a better understanding of the invention, although they may be simplified or understood according to the needs of the market:

Access step: it consists of all the access recognizing processes, and may take place through one or more reader devices 2 and through the various company card formats 6 or virtual card already described, such as credit cards, debit cards, magnetic stripe cards, smart cards, access-password cards, product bar codes, code-scratch-off cards, etc. The reading devices 2, herein called readers, may be conventional, from stripe readers, chips, inductive, etc., to readers for identification through bar codes, data-inputting, etc. For this access step, the fundamental thing is that the user be identified and mainly to which company he belongs (so that the control station 4 can use the corresponding business rules defined by the administrative area 5);

Identification step: it consists of all the procedures for identifying the user and the company that is sharing the public access terminal with telephony, including authentication of the user;

Recognition step: it checks the company that is sharing the public access terminal, the contents that will be presented to the user, as if the public access terminal 1 were of entire ownership of the latter;

Presentation step: display of the company information.

Since all content presented by the public access terminal 1 is exactly the one established and confectioned by the company that is sharing this terminal and considering that such company has been detected by the identification of the user who owns the access card 6, in practice the user recognizes the terminal 1 and the contents as if they were totally dedicated for the company that is client, although in reality this fact has been occurring only during the period of time in which the user is using the public access terminal with telephony 1.

Thus, even small companies can share network terminals in several countries, and the access card 6 supplied to the user and/or client of the company is then the access key to any terminal of the network.

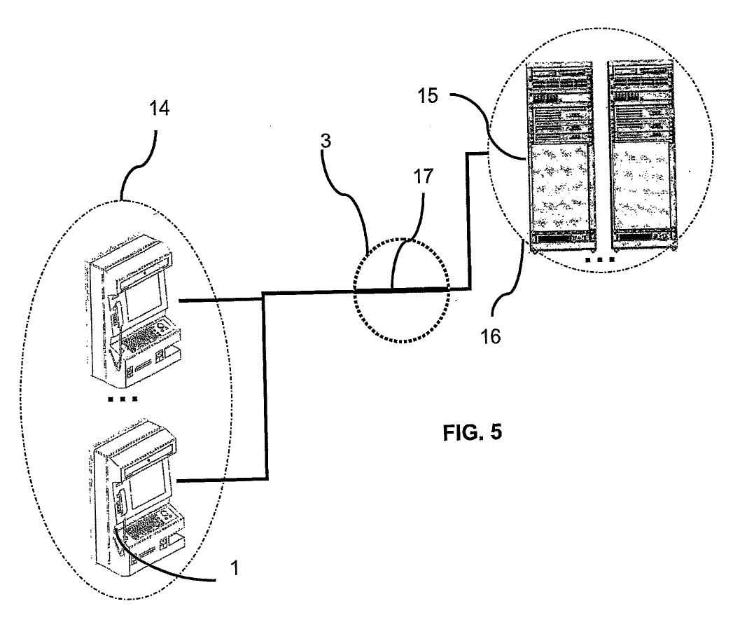

FIG. 5 illustrates the modular system for administering and controlling public access terminals with telephony, which controls an undetermined number of terminals with any volume of operations in execution, without capacity limitation. As can be seen in this FIG. 5, the modular device 15 may be interconnected with other devices at the same level or layer 16, enabling the redundancy and also enabling the share of control and information traffic. The modular device 15 may be located anywhere with network connection 17, such connection 17 being a private and safe connection between the access terminals and between the modular device 15 control stations, using the same security standard of Extranets through Ethernet and VPN in TCP/IP network, in conjunction with a number of Firewall and data cryptography devices available at the control stations. However, these resources and the network may be replace by other protocols available on the market, the network being exactly in the same standard presented in FIG. 1, but repeated in modules, where at least one public access terminal assembly 14 with telephony is connected.

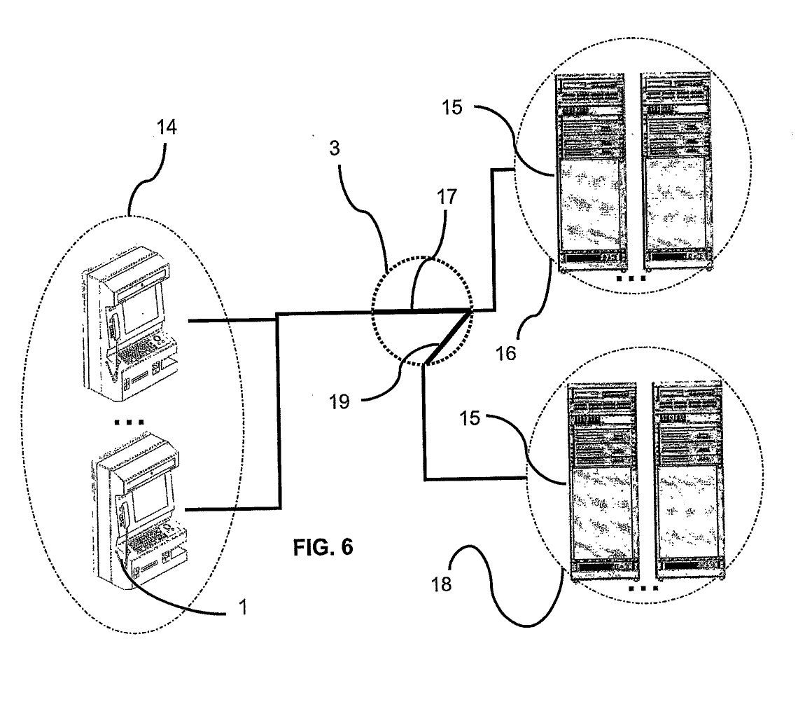

The modularity may be both horizontal (same level or layer) and vertical, as it can be seen on FIG. 6, where the same modular device 15 is replicated in an upper control layer 18, connected directly to the lower layer through a security connection 19, which is a high-security Internet-type connection, considering that it interconnects only servers of the company or internal administrative work stations, although in practice it can also be considered as an Extranet, since the stations may be physically away form each other, logically and physically connected through the connection 19, using the same security standard of Extranets through Ethernet and VPN in TCP/IP network, in conjunction with a plurality of Firewall and data-cryptography control devices available at the control stations, and these may be replaced with other protocols available on the market. The expansion of layers of the modular system has no limits and can continue successively, according to the needs of business rules, expansion, security, velocity, latency, control, etc.

Through the modular device 15, it is possible to make available to the public various access services such as navigation on the Internet, electronic mail, electronic trade, advertising, telephony, etc., with a safe and fast service, and at a low cost for an effective digital inclusion of a larger number of people.

According to the structure arranged on FIGS. 5 and 6, the modular system guaranties the administration and control over any number of public access terminals 1 with telephony, through the following characteristics:

Redundancy characteristic: all the modular devices 15 available have resources that can replace the fault devices, according to possible local problems in the places where they are installed. The redundancy functions as follows: a priori, all the public access terminals can be connected to any control station 4 or modular device 15 belonging to the network, the choice of the station and/or device being made by on the basis of several factors, such as proximity, location, network latency, etc. This is fundamental, since the access terminals are installed at the most varied places and the control stations are remote, which makes it important to foresee the temporary failure in communication between a terminal and a specific station. In the same way, it is possible to check the communication between the control stations 4 and the modular devices 15 and the replication layers 18, where the hierarchy of the control system is expanded.

Capillarity characteristics: once the capacity of a modular system has been reached when serving a given number of public access terminals 1, it is possible to insert a further modular device 15 for controlling and administering a new group 14 of public access terminals 1. In the same way, when more than one layer 16 is arranged, the upper layers 18 may be expanded, and additional modular devices are inserted for controlling the modular systems of the lower layer. The capillarity is fundamental for enabling the expansion of users resources, with the fast enlarge of band and applications, as for example, applications of IP telephony and video and audio transmission in real time.

Communicability characteristics: it is possible to create communication layers between the systems and the remote databank, such layers interlinked to any modular device 15, or to a plurality ones simultaneously, according to the market needs and according to the involved applications.

Administration characteristics: the modular devices 15 administration 15 can be both locally and in a remote way, through any operator connected to the network.

The multiplicity of possible architectures to be implanted is due to the modularity of the devices 15, which makes possible a flexible network for amplitude of service to large geographic regions and with the most varied connectivity methods.

In addition, the modular systems can operate with safe and encrypted networks since there is no risk of latency and delay in serving due to the modular structure and to the redundancy capacity in the connection, both in the public access terminals connected to the application servers and in the other modular systems in various control and administration layers.

All the interface, mode and sharing systems presented above, when arranged in conjunction, provide a public access system that enables digital insertion and interaction of the final user and the convergence of the most varied on-line resources and services, with a simple touch on the screen of a public access terminal with telephony.

Therefore, one should understand that the object of the present invention and its parts and components systems described above are part of some of the preferred embodiments and examples of situations that might occur, the real scope of the invention being defined in the accompanying claims.

1. A dynamic operation interface system for access terminals, characterized by comprising:
at least one access terminal (1) composed of interface means (11), at least one telephone (20) and display means (12);
at least one content-control station (4), interconnected to at least one access terminal through a communication means (3); and
at least one administrative area (5), interconnected to at least one control station (4) through a connection (7);
wherein said interface means (11) comprises a plurality of hierarchical buttons (13), created from conversions of electronic address links (10) effected by the content-control station (4) and by the administrative area (5).

2. A dynamic operation interface system according to claim 1, characterized in that the hierarchical buttons (13) are created from automatic or manual conversions.

3. A dynamic operation interface system according to claim 1, characterized in that the access terminal (1) is a public access terminal with telephony of public use.

4. A dynamic operation interface system according to claim 1, characterized in that the access terminal further comprises an inputting keyboard (22), a QWERTY keyboard (23), audio means (24), camera (26), mouse (26), printing means (30), biometric sensor (31) and a telephone viewer (32).

5. A dynamic operation interface system according to claim 1, characterized in that the display means (12) of the access terminal (1) is a touch-sensitive screen.

6. A dynamic operation interface system according to claim 1, characterized in that the content-control station (4) can further be a conventional data processing center.

7. A dynamic operation interface system according to claim 1, characterized in that the communication means (3) is a network.

8. A dynamic operation interface system according to claim 7, characterized in that the network has an Ethernet standard and TCP/IP Internet protocol.

9. A dynamic operation interface system according to claim 1, characterized in that the connection (7) has an Ethernet standard and PCT/IP Internet protocol.

10. A sharing system at access terminals, characterized by comprising:
at least one access terminal (1) composed of an interface means (11), at least one telephone (20), display means (12) and at least one reading means (2) coupled with at least one identification means (6);
at least one content-control station (4) interconnected to at least one access terminal through the communication means (3);
at least one administration area (5), interconnected to at least one control station (4) through a connection (7).

11. A sharing system at access terminals according to claim 10, characterized in that the reading means (2) and the identification means (6) are the key of access to the terminal, released by the control station (4).

12. A sharing system at access terminals according to claim 10, characterized in that the access terminal is a public access terminal with telephony of public use.

13. A sharing system at access terminals according to claim 10, characterized in that the access terminal further comprises an inputting keyboard (22), a QWERTY keyboard (23), audio means (24), camera (26), mouse (28), printing means (30) and a telephone viewer (32).

14. A sharing system at access terminals according to claim 10 or 11, characterized in that the reading means (2) is a reader from the group consisting of magnetic stripe readers, smart-card chip readers, inductive readers, bar-code readers, input readers, among others.

15. A sharing system at access terminals according to claim 10 or 11, characterized in that the identification means (6) is a device from the group consisting of credit cards, debit cards, magnetic stripe cards, smart cards, access-password cards, products bar-codes, code-scratch-off cards, among others.

16. A sharing system at access terminals according to claim 10, characterized in that the display means (12) of the access terminal (1) is a touch-sensitive screen.

17. A sharing system at access terminals according to claim 10, characterized in that the communication means (3) is a network.

18. A sharing system at access terminals according to claim 17, characterized in that the network has an Ethernet standard and TCP/IP Internet protocol.

19. A sharing system at access terminals according to claim 17, characterized in that the network uses Renpac protocols.

20. A sharing system at access terminals according to claim 17, characterized in that the network is a VPN.

21. A sharing system at access terminals according to claim 10, characterized in that the connection (7) has an Ethernet standard and TCP/IP Internet protocol.

22. A modular system for administering and controlling access terminals, characterized by comprising:
at least one access-terminal (1) assembly (14); and
at least one modular means (15) interconnected to said at least one access terminal assembly (14) through a connection (17) with the network (3);
wherein the modular means (15) are connected with each other in an undetermined manner at the same layer level (16) and at undetermined levels of different layers (18) through a security connection (19).

23. A modular system for administering and controlling access terminals according to claim 22, characterized in that the connection (17) is a private connection using Ethernet standard and VPN and TCP/IP Internet protocol.

24. A modular system for administering and controlling access terminals according to claim 22, characterized in that the security connection (19) is an Internet-, Extranet-, Ethernet- and VPN-type TCP/IP network.

25. A public access terminal system with telephony, characterized by comprising:
said dynamic operation interface system as defined in any of the preceding claims 1 to 9,
said sharing system at access terminals as defined in any of the preceding claims 10 to 21; and
said modular system for administering and controlling access terminals, as defined in any of the preceding claims 22 to 24.
